(19) United States
(12) Patent Application Publication
(10) Pub. No.: US 2016/0060133 A1
(43) Pub. Date: Mar. 3, 2016

(54) REMOVAL OF METALS AND CATIONS THEREOF FROM WATER-BASED FLUIDS

(71) Applicant: BAKER HUGHES INCORPORATED, Houston, TX (US)

(72) Inventors: DANIEL P. VOLLMER, Lafayette, LA (US); Alan M. Trahan, Broussard, LA (US)

(73) Assignee: BAKER HUGHES INCORPORATED, Houston, TX (US)

(21) Appl. No.: 14/829,784

(22) Filed: Aug. 19, 2015

Related U.S. Application Data
(60) Provisional application No. 62/042,625, filed on Aug. 27, 2014.

(51) Int. Cl. C02F 1/00; C02F 1/52; C02F 1/38

(52) U.S. Cl. CPC C02F 1/001; C02F 1/38; C02F 1/5236; C02F 2101/20

(57) ABSTRACT

At least one solid may be separated from a water-based fluid by flowing the water-based fluid through a filter media in combination with filtration equipment, such as a filter press. In a non-limiting embodiment, the filter media may be or include, but is not limited to, diatomaceous earth and at least one alkaline earth metal(s). The solid(s) may be or include a metal, such as but not limited to zinc, iron, manganese, mercury, nickel, cations thereof, and combinations thereof. In a non-limiting embodiment, the water-based fluid may be or include a production fluid, a drilling fluid, a drill-in fluid, a completions fluid, a fracturing fluid, a servicing fluid, a stimulation fluid, a treating fluid, and combinations thereof.

### CROSS-REFERENCE TO RELATED APPLICATION

This application claims the benefit of U.S. Provisional Patent Application Ser. No. 62/042,625 filed Aug. 27, 2014, incorporated herein by reference in its entirety.

### FIELD OF THE INVENTION

The present invention relates to separating metals and cations thereof from a water-based fluid by flowing the water-based fluid through a filter media used in combination with filtration equipment, such as a filter press, and more specifically relates to methods of using a filter media comprising diatomaceous earth and at least one alkaline earth metal to at least partially separate at least one separable metal from the water-based fluid.

### BACKGROUND

Diatomaceous earth may be used as a filter aid in combination with filtration equipment, in a non-limiting embodiment such as a filter press for separating various contaminants from water-based fluids. Diatomaceous earth products may be obtained from diatomaceous earth (also called “DE” or “diatomite”), which is generally known as a sediment enriched in biogenic silica (i.e., silica produced or brought about by living organisms) in the form of siliceous skeletons (frustules) of diatoms. Diatoms are a diverse array of microscopic, single-celled, golden-brown algae generally of the class Bacillariophyceae that possess an ornate siliceous skeleton of varied and intricate structures comprising two valves that, in the living diatom, fit together much like a pill box.

In the field of filtration, methods of particle separation from fluids may employ diatomaceous earth products as filter aids. The intricate and porous structure unique to diatomaceous earth may, in some instances, be effective for the physical entrapment of particles in filtration processes. Diatomaceous earth products may improve the clarity of fluids that exhibit turbidity or contain suspended particles or particulate matter.

Diatomaceous earth may be used in various embodiments of filtration. As a part of pre-coating, diatomaceous earth products may be applied to a filter septum to assist in achieving, for example, any one or more of: protection of the septum, improvement in clarity, and expediting filter cake removal from a filter press (not the filter cakes typically formed within a wellbore from drilling fluids). As a part of body feeding, diatomaceous earth may be added directly to a fluid being filtered to assist in achieving, for example, either or both of: increased flow rate and extensions of the filtration cycle. Depending on the requirements of the specific separation process, diatomaceous earth may be used in multiple stages or embodiments including, but not limited to, in pre-coating and in body feeding. Processing very finely divided diatomaceous earth, including the diatomaceous earth ore may form diatomaceous earth products. For example, in order to obtain a product suitable for use as a filter aid, finely divided diatomaceous earth may be granulated in an agglomeration process.

Diatomaceous earth may be used as part of a filtration process to separate and/or remove solids from a water-based fluid. Any solids remaining in the water-based fluid may cause issues during refining or processing of the water-based fluid if the solids are not removed. Such water-based fluids may be or include a production fluid, a drilling fluid, a completion fluid, a fracturing fluid, a servicing fluid, a stimulation fluid, a treating fluid, and combinations thereof.

“Water-based fluids” are fluids having an aqueous continuous phase where the aqueous continuous phase is all water, an oil-in-water emulsion, or an oil-in-brine emulsion. In water-based downhole fluids, solid particles may be suspended in a continuous phase consisting of water or brine. Oil may be emulsified in the water or brine; therefore, the water or brine is the continuous phase.

There are a variety of functions and characteristics that are expected of completion fluids. The completion fluid may be placed in a well to facilitate final operations prior to initiation of production. Such final operations include, but are not necessarily limited to, setting screens, production lines, packers and/or downhole valves, and shooting perforations into the producing zones. The completion fluid assists with controlling a well if downhole hardware should fail, and the completion fluid does this by minimizing damage of the producing formation or completion components. Completion operation may include perforating the casing, and setting the tubing and pumps in petroleum recovery operations. Both workover and completion fluids are used in part to control well pressure, to prevent the well from blowing out during completion or workover, or to prevent the collapse of well casing due to excessive pressure build-up.

Chemical compatibility of the completion fluid with the reservoir formation and other fluids used in the well is key to avoid formation damage. Chemical additives, such as polymers and surface active materials are known in the art for being introduced to the well servicing fluids for various reasons that include, but are not limited to, increasing viscosity, and increasing the density of the fluid. Water-thickening polymers serve to increase the viscosity of the fluid and thus lift drilled solids from the well-bore. The completion fluid is usually filtered to a high degree to reduce the amount of solids that would otherwise be introduced to the near-wellbore area. A regular drilling fluid is usually not compatible for completion operations mainly because of its solids content.

Production fluids also have a multitude of functions and characteristics necessary for carrying out the production of the well. As used herein, the terms “produced fluids” and “production fluids” refer to liquids and/or gases removed from a subsurface formation, including, for example, an organic-rich rock formation. Said differently, a production fluid is any fluid that comes out of a well, i.e. produced from the well. Produced fluids may include both hydrocarbon fluids and non-hydrocarbon fluids. Production fluids may include, but are not limited to, pyrolyzed shale oil, synthesis gas, a pyrolysis product of coal, carbon dioxide, hydrogen sulfide, and water (including steam). Produced oil quality, overall production rate, and/or ultimate recoveries may be altered by altering the production fluid. Generally, all precautionary means may be taken to assure that the production flow from the well is uninterrupted or said differently, to maintain the flow assurance of the well, such as preventing asphaltenes deposition, scale deposition, wax deposition, and/or hydrates from forming within the production fluids.

The resulting hydrocarbon stream from a producing well is a mixture that must be separated into its gross components, such as oil, gas, and water. The phases of the hydrocarbon stream must also be separated; i.e. the liquids from the vapors. Two-phase separators separate phases only, such as the vapor from the liquid hydrocarbon. Three-phase separators are necessary when the production fluid also contains water that must be removed. Once the hydrocarbon stream goes through the separator, the resultant production streams are processed according to whether it is a gas stream or an oil stream. Crude oil may be a component within a production fluid that is separable therefrom.

The processing of crude oil involves removing contaminants, such as sand, salt, H₂O, sediments, and other contaminants. However, H₂O is the largest contaminant in oil or gas. Several units may be employed to remove such contaminants from the oil stream. A heater-treater may be used to break up the oil-H₂O emulsion. A free-water knockout vessel separates free water from the oil stream produced from the well. An electrostatic heater treater employs an electric field to separate the water from the oil stream by attracting the electric charge of the water molecules. Demulsifying agents may be used to break emulsions by use of chemicals.

Servicing fluids, such as remediation fluids, workover fluids, and the like, have several functions and characteristics necessary for repairing a damaged well. Such fluids may be used for breaking emulsions already formed. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations.

Before performing remedial operations, the production of the well must be stopped, as well as the pressure of the reservoir contained. To do this, any tubing-casing packers may be unseated, and then servicing fluids are run down the tubing-casing annulus and up the tubing string. These servicing fluids aid in balancing the pressure of the reservoir and prevent the influx of any reservoir fluids. The tubing may be removed from the well once the well pressure is under control. Tools typically used for remedial operations include, but are not necessarily limited to, wireline tools, packers, perforating guns, flow-rate sensors, electric logging sondes, etc.

The development of suitable fracturing fluids is a complex art for use with hydraulic fracturing to improve the recovery of hydrocarbons from the formation. Once hydraulic fracturing begins, and the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons.

The fracturing fluids must simultaneously meet a number of conditions. For example, they must be stable at high temperatures and/or high pump rates and shear rates that can cause the fluids to degrade and prematurely settle out the proppant before the fracturing operation is complete. Various fluids have been developed, but most commercially used fracturing fluids are aqueous based liquids that have either been gelled or foamed. When the fluids are gelled, typically a polymeric gelling agent, such as a solvatable polysaccharide, e.g. guar and derivatized guar polysaccharides, is used. The thickened or gelled fluid helps keep the proppants within the fluid. Gelling can be accomplished or improved by the use of crosslinking agents or cross-linkers that promote crosslinking of the polymers together, thereby increasing the viscosity of the fluid. One of the more common cross-linked polymeric fluids is borate cross-linked guar.

A water-based refinery fluid or feed is defined as any water-based fluid where the fluid is further refined or has been further refined, e.g. additives may be added to a production fluid or compounds may be removed from the production fluid at a refinery. Such fluid may be considered a production fluid and a refinery fluid. Refinery fluids are typically associated with refining of production fluids for purposes herein.

It would be desirable if better diatomaceous earth filter aids (also known as filter media) were created to remove more solids from water-based fluids.

### SUMMARY OF THE INVENTION

There is provided, in one form, a method for removing solids from a water-based fluid by flowing a water-based fluid through filtration equipment at least a first time where the filtration equipment may include a filter media. The filter media may include an effective amount of diatomaceous earth and an effective amount of at least one alkaline earth metal or compound thereof to separate at least one solid from the water-based fluid. The method may include at least partially separating the solid(s) from the water-based fluid to form a filtered water-based fluid.

There is further provided, in another non-limiting form of the method where the solid is a metal, such as but not limited to zinc, iron, manganese, mercury, nickel, cations thereof, and combinations thereof. The filtered water-based fluid may have a pH greater than at least 8.5.

In yet another non-limiting form of the method, the water-based fluid may be or include, but is not limited to, a production fluid, a drilling fluid, a drill-in fluid, a completions fluid, a fracturing fluid, a servicing fluid, a stimulation fluid, a treating fluid, and combinations thereof

The alkaline earth metal(s) within the filter media may react with the solid(s) to form a precipitate, which may be separated from the water-based fluid.

### DETAILED DESCRIPTION OF THE INVENTION

It has been discovered that an effective amount of an alkaline earth metal within a filter media used in combination with filtration equipment, including but not necessarily limited to a filter press, may separate an increased amount of at least one solid from a water-based fluid flowed therethrough as compared to the amount of solid(s) separated from the water-based fluid in the absence of the alkaline earth metal(s) within the filter media. The filter media may include diatomaceous earth and at least one alkaline earth metal. The alkaline earth metal(s) within the filter media may be or include, but are not limited to, magnesium, calcium, barium, oxides thereof, hydroxides thereof, halides thereof, carbonates, phosphates, and combinations thereof. In a non-limiting embodiment, the halides may be chlorides.

In another non-limiting embodiment, the size of the alkaline earth metals may range from about 10 nm independently to about 200 microns, alternatively from about 50 nm independently to about 150 microns, or from about 100 nm independently to about 100 microns. As used herein with respect to a range, “independently” means that any threshold may be used together with another threshold to give a suitable alternative range, e.g. about 10 nm independently to about 50 nm is also considered a suitable alternative range.

The filter media may be created by mixing an effective amount of diatomaceous earth with an effective amount of at least one alkaline earth metal. The filter media may be applied to a filter press by use of a vacuum, as mentioned in the examples below. In an alternative non-limiting embodiment, the filter media may be mixed with the water-based fluid prior to flowing the water-based fluid through the filter press. Other methods of forming and using the filter media are well-known to those skilled in the art of separating solids. For purposes of filtration, the water-based fluid is considered to ‘flow through’ the filter media and/or filter press regardless of whether the filter media is applied to the filter press or incorporated into the water-based fluid prior to flowing the water-based fluid through the filter press. ‘Effective amount’ is defined herein to mean any amount of the diatomaceous earth and/or alkaline earth metal (and alkaline earth metal compounds) that may separate at least a portion of solid(s) from the water-based fluid.

Complete separation and/or removal of the solid(s) from the water-based fluid is desirable, but it should be appreciated that complete separation/removal is not necessary for the methods discussed herein to be considered effective. Success is obtained if more solid(s) are separated when flowing the water-based fluid through the filter media than in the absence of the filter media. Alternatively, the methods described are considered successful if a majority of the solid(s) are separated from the water-based fluid, alternatively the amount of separated solid(s) may range from about 70 wt % independently to about 99.99 wt %, or from about 95 wt % independently to about 99.9 wt %, or from about 95 wt % independently to about 99 wt % in another non-limiting embodiment. ‘Majority’ is defined herein to be an amount of at least 51% or greater. The solid(s) may be or include metal(s), such as but not limited to, zinc, iron, manganese, mercury, nickel, cations thereof, compounds thereof, and combinations thereof.

In a non-limiting embodiment, the size of the solid(s) may range from about 10 nm independently to about 200 microns, alternatively from about 50 nm independently to about 150 microns, or from about 100 nm independently to about 100 microns.

In addition or in the alternative, once the water-based fluid has passed through the filter media at least a first time, the amount of the solid(s) remaining therein may range from about 0.1 ppm independently to about 50 ppm, alternatively from about 1 ppm independently to about 25 ppm, or from about 2 ppm independently to about 5 ppm in another non-limiting embodiment.

Prior to flowing the water-based fluid through the filter media, the water-based fluid may have a pH ranging from about 4 to about 7. After the water-based fluid passes through the filter media at least a first time, the water-based fluid may progressively become more basic with regards to pH with each flowing of the water-based fluid through the filter media. A basic pH of the water-based fluid may indicate that a majority of the solid(s) has been removed from the water-based fluid. In a non-limiting embodiment, the water-based fluid may need to be flowed through the filter media a second time or more until the water-based fluid acquires a basic pH. However, if the pH of the water-based fluid does not become progressively more basic with each passing of the water-based fluid through the filter media, the filter media and/or filter press may need to be cleaned and/or replaced.

In a non-limiting embodiment, the basic pH of the filtered water-based fluid may be at least 8.5; alternatively, the basic pH may range from about 8.5 independently to about 10.5, alternatively from about 8.7 independently to about 10.3, or in another non-restrictive version from about 8.9 independently to about 10.1 in another non-limiting embodiment. In yet another non-limiting embodiment, the basic pH may be at least 9.

In a non-limiting example, the water-based fluid may be flowed through the filter media a first time where a portion of the solid(s) is separated from the water-based fluid. The same water-based fluid may be flowed through the filter media a second time to separate an additional portion of the solid(s) from the water-based fluid and so on. The water-based fluid may be flowed through the filter media as many times as necessary until a desired amount of the solid(s) has been separated from the water-based fluid. With each additional portion of solid(s) separated from the water-based fluid, the pH of the water-based fluid may become more basic as mentioned above.

Assuming that an effective amount of diatomaceous earth and/or alkaline earth metal(s) are present within the filter media, the amount of solid(s) separated from the water-based fluid with each flow through the filter media may depend on the flow rate of the water-based fluid through the filter media. The water-based fluid may be flowed through the filter media at any rate; however, an increased amount of solid(s) may be separated from the water-based fluid when the water-based fluid is flowed through the filter media at a slower rate. Said differently, fewer solid(s) may be separated from the water-based fluid when flowed through the filter media at a faster rate as compared to a water-based fluid flowed through the filter media at a slower rate. Although the inventors do not wish to be bound to a particular theory, it is thought that the flow rate of the water-based fluid may depend on the reaction kinetics of the alkaline earth metal(s) with the solid(s) to form a separable precipitate.

The filter media may have or include the diatomaceous earth in an amount ranging from about 1 wt % independently to about 99 wt %, alternatively from about 20 wt % independently to about 80 wt %, or from about 40 wt % independently to about 60 wt %. The filter media may have or include the alkaline earth metal(s) in an amount ranging from about 1 wt % independently to about 99 wt %, alternatively from about 20 wt % independently to about 80 wt %, or from about 40 wt % independently to about 60 wt %. In a non-limiting embodiment, the ratio of the diatomaceous earth to the alkaline earth metal(s) may be 1:1, i.e. a 50/50 ratio as noted in the Examples below.

In a non-limiting embodiment, the effective amount of diatomaceous earth within the filter media ranges from about 2 pounds per one hundred (pph) barrels (100 bbl) independently to about 50 lb per one barrel (1 bbl) of water-based fluid; alternatively from about 5 pph independently to about 20 lb per one barrel (1 bbl) of water-based fluid. The effective amount of at least one alkaline earth metal or compound thereof within the filter media ranges from about 2 pounds per one hundred barrels (100 bbl) independently to about 50 lb per one barrel (1 bbl) of water based fluid; alternatively from about 5 pph independently to about 20 lb per one barrel (1 bbl) of water based fluid.

Suitable alkaline earth metals include, but are not necessarily limited to, magnesium, calcium, strontium, barium, and combinations thereof. Suitable alkaline earth metal compounds include, but are not necessarily limited to, magnesium oxide, magnesium hydroxide, magnesium carbonate hydroxide, calcium oxide, calcium hydroxide, and combinations thereof.

In a non-limiting embodiment, the water-based fluid may include at least one caustic material prior to flowing the water-based fluid through the filter media. The caustic material may be or include, but is not limited to, sodium hydroxide, potassium hydroxide, sodium carbonate, potassium carbonate, and combinations thereof. The caustic material may be added to the water-based fluid by adding the caustic material directly to the water-based fluid, injecting the caustic material into the water-based fluid or a water-based feed, circulating the caustic material into the water-based fluid, and combinations thereof. A ‘water-based feed’ is a water-based fluid that is flowed through a system that includes a filter media and filter press. The caustic material may be added to the water-based fluid or water-based feed at any point prior to passing the water-based fluid through the filter media. In a non-limiting embodiment, the amount of caustic material to be added to the water-based fluid may range from about 50 ppm independently to about 5000 ppm, or from about 100 ppm independently to about 1000 ppm.

In an alternative non-limiting embodiment, the water-based mixture does not include a caustic material.

In a non-limiting embodiment, the water-based fluid may include a hydrazine complexing agent prior to flowing the water-based fluid through the filter media. The hydrazine complexing agent may be added to the water-based fluid by adding the hydrazine complexing agent directly to the water-based fluid, injecting the hydrazine complexing agent into the water-based fluid or a water-based feed, circulating the hydrazine complexing agent into the water-based fluid, and combinations thereof. The hydrazine complexing agent may be added to the water-based fluid or water-based feed at any point prior to passing the water-based fluid through the filter media.

The hydrazine (H₂N—NH₂) complexing agent may form an insoluble metal complex with the separable metal(s) within the water-based fluid. The insoluble metal complex may be or include, but is not limited to, a zinc metal complex, an iron metal complex, a manganese metal complex, a mercury metal complex, a nickel metal complex, and combinations thereof. The insoluble metal complex may then be removed from the water-based fluid. The effective amount of the hydrazine complexing agent may range from about 10 wt % to about 50 wt % (about 100,000 to about 500,000 ppm), alternatively from about 20 wt % to about 40 wt % (about 200,000 to about 400,000 ppm). And in one such embodiment, the amount may be about 35 wt % (about 350,000 ppm).

The molar ratio of hydrazine to the separable solid(s) (e.g. metal(s)) may range from about one to about three moles of hydrazine to about one mole of the separable solid(s). In a non-limiting example, it may be desirable to use from about 2 to about 3 moles of hydrazine for each mole of separable solid present in the water-based fluid to be treated. If less solid is present in the water-based fluid, less hydrazine may be included in the water-based fluid.

The removing of the insoluble metal complex from the water-based fluid may occur by a process, including but not necessarily limited to filtering, centrifugation, settling, and combinations thereof. Then, the metal may be separated from the insoluble metal complex to form a reusable metal. The separation may be performed in any way known to be useful to those of ordinary skill in the art. In a non-limiting example, the insoluble metal complex may be treated with a peroxide to produce a reusable metal salt, such as zinc bromide in a non-limiting embodiment. The reusable metal may then be added to another water-based fluid, or even the same water-based fluid if so desired.

‘Separate’ is defined herein to include any physical or chemical process to decrease the ability of the solid or metal to contaminate the water-based fluid. In other words, the separable solid or metal may still be physically present in the water-based fluid but physically or chemically unable to react with other compounds in the water-based fluid. Such inactivation of the separable solid(s) is considered ‘separated’ and/or ‘removed’ from the water-based fluid for purposes herein. Similarly, ‘separation’ is defined as the process of ‘separating’ to use the term ‘separate’ as previously defined.

‘Reusable’ as used herein is defined to mean that the separable metal(s) may be used as salts to mix with water to create a brine suitable as a drilling fluid, such as a zinc bromide brine. The reusable metal(s) may also be used for creating brines that may be or include calcium bromide, sodium bromide, calcium chloride, and combinations thereof. Alternatively, the hydrazine complexing agent may be reusable once the complexing agent has been separated from the insoluble metal complex.

Water-based fluid is defined as any fluid having water as a base for the fluid or solution, or that includes water as the continuous phase of an emulsion. Such water-based fluids may be or include brine-based fluids. In a non-limiting embodiment, the water-based fluid may be or include a production fluid, a drilling fluid, a drill-in fluid, a completions fluid, a fracturing fluid, a servicing fluid, a stimulation fluid, a treating fluid, and combinations thereof. The water-based fluid may comprise an emulsion where water is a continuous or external phase and a non-aqueous discontinuous or internal phase is present. Such a non-aqueous discontinuous or internal phase may include, but is not necessarily limited to, oil and/or alcohol or glycol. Of course, the water-based fluid need not comprise oil, alcohol, or glycol at all.

Filtration equipment are well-known to those skilled in the art. However, non-limiting examples of filtration equipment usable with the filter media may be or include plate and frame, recessed-plate, automatic filter press, horizontal plate filter, industrial tubular filter, external-cake tubular filters, pressure leaf filter, centrifugal-discharge filter, continuous cake filters, horizontal-belt filter cartridge clarifiers, and the like.

### EXAMPLES

The following examples are provided to illustrate the present invention. The examples are not intended to limit the scope of the present invention, and they should not be so interpreted.

### Example 1

A produced water sample was obtained from a producing well containing 300 mg/L of zinc, and the produced water sample had a pH of 5.6. A uniform mixture of 5 grams of magnesium oxide and 5 grams of diatomaceous earth was placed on top of a filter paper inside a funnel. The uniform mixture functioned as the filter media. A vacuum was applied to the uniform mixture using a vacuum pump to keep the filter media down. 382 grams of produced water was poured onto the filter aid and allowed to completely flow through. 30 mL of the filtered produced water was collected as a first sample, and the remainder of the first sample of the filtered produced water was poured through the same filter media a second time. 30 mL of the second filtered produced water was collected as a second sample. Inductively coupled plasma (ICP) was used to measure the zinc in the first sample of the filtered produced water (i.e. the first filtration pass) to be 23.6 mg/L, and the second sample of the filtered produced water (i.e. the second filtration pass) to be 1.9 mg/L. The final pH of the second sample of the produced water was 9.0.

### Example 2

Example 1 was repeated where the filter media included 25 grams of magnesium oxide and 25 grams of diatomaceous earth. The produced water sample included 300 mg/L of zinc, the Fe concentration was 20 mg/L, and the manganese concentration was 3 mg/L and had a pH of 5.6. The first filtration pass of the sample had a zinc concentration of 0.7 mg/L, and the second filtration pass had a zinc concentration of 0.4 mg/L, and 0 mg/L for both iron and manganese as noted in TABLE 1. The final pH of the second sample of the filtered produced water was 9.8. The results are also shown in TABLE 1 below.

TABLE 1
Concentration of Solids Before and After Treatment

| | Produced Water | Produced Water |
|---|---|---|
| | (Pre-treatment) | (Post-treatment, 2^{nd} pass) |
| Zn (mg/L) | 300 | 0.4 |
| Fe (mg/L) | 20 | 0 |
| Mn (mg/L) | 3 | 0 |
| pH | 5.7 | 9.8 |
| standard gravity | 1.092 at 75° F. | 1.096 at 70.4° F. |

### Example 3

Example 1 was repeated for three samples of produced water. Each sample was flowed through a filter media that included 10 grams of magnesium oxide and 10 grams of diatomaceous earth. Sample 1 did not include hydrazine; sample 1 was the ‘blank’. Hydrazine was injected into sample 2 at a rate of 100 ppm, and hydrazine was injected into sample 3 at a rate of 250 ppm. All samples were shaken 75 times, and then the samples were allowed to settle over a period of 10 minutes prior to filtering the samples.

The first filtration pass for sample 1 was 8 minutes; the first filtration pass for sample 2 was 12.5 minutes; the first filtration pass for sample 3 was 10.5 minutes. The zinc concentration for sample 1 after the first filtration pass was 23.6; the zinc concentration for sample 2 after the first filtration pass was 17.6; the zinc concentration for sample 3 after the first filtration pass was 3.9.

The second filtration pass for sample 1 was 7.25 minutes; the second filtration pass for sample 2 was 7.5 minutes; the second filtration pass for sample 3 was 7.5 minutes. The zinc concentration for sample 1 after the second filtration pass was 1.9; the zinc concentration for sample 2 after the second filtration pass was 0.9; the zinc concentration for sample 3 after the second filtration pass was 3.1. The pH after the second filtration pass for sample 1 was 9; the pH after the second filtration pass for sample 2 was 9.75; the pH after the second filtration pass for sample 3 was 9.45. The results are also shown in TABLE 2 below.

TABLE 2
Treatment of Produced Water with a Filter Media and Hydrazine

| | | | | 1st | | 2nd | | |
|---|---|---|---|---|---|---|---|---|
| | | | | Filtration | 1st Zinc | Filtration | 2nd Zinc | |
| | Injection | Media | Settling | Time | Reading | Time | Reading | Final |
| | Rate | (10 g) | Time | (mins) | ICP (Zn) | (mins) | ICP (Zn) | pH |
| Blank | N/A | MgO/DE | 10 | 8 mins | 23.6 | 7.25 | 1.9 | 9 |
| | | (10 g) | | | | | | |
| Hydrazine | 100 | MgO/DE | 10 | 12.5 mins | 17.6 | 7.5 | 0.9 | 9.75 |
| | | (10 g) | | | | | | |
| Hydrazine | 250 | MgO/DE | 10 | 10.5 mins | 3.9 | 7.5 | 3.1 | 9.45 |
| | | (10 g) | | | | | | |

The above non-limiting examples illustrate a separation and reduction of zinc from the produced water by flowing the water-based fluid through a filter media having diatomaceous earth and at least one alkaline earth metal.

In the foregoing specification, the invention has been described with reference to specific embodiments thereof, and has been described as effective in providing methods for separating solids from a water-based fluid. However, it will be evident that various modifications and changes can be made thereto without departing from the broader spirit or scope of the invention as set forth in the appended claims. Accordingly, the specification is to be regarded in an illustrative rather than a restrictive sense. For example, water-based fluids, alkaline earth metals, types of DE, solids, specific hydrazine complexing agents, other additives, filter presses, proportions and reaction conditions falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method for removing solids from a water-based fluid may consist of or consist essentially of flowing a water-based fluid through filtration equipment at least a first time where the filtration equipment may include a filter media and at least partially separating the solid(s) from the water-based fluid to form a filtered water-based fluid; the filter media may include an effective amount of diatomaceous earth and an effective amount of at least one alkaline earth metal or compound thereof to separate at least one solid from the water-based fluid.

The words “comprising” and “comprises” as used throughout the claims, are to be interpreted to mean “including but not limited to” and “includes but not limited to”, respectively.

What is claimed is:

1. A method for removing at least one solid from a water-based fluid comprising:
flowing a water-based fluid through filtration equipment at least a first time where the filtration equipment comprises a filter media, and the filter media in turn comprises an effective amount of diatomaceous earth and an effective amount of at least one alkaline earth metal or compound thereof to at least partially remove the at least one solid from the water-based fluid; and
at least partially separating the solid(s) from the water-based fluid to form a filtered water-based fluid.

2. The method of claim 1 where the at least one solid is a metal selected from the group consisting of zinc, iron, manganese, mercury, nickel, cations of these metals, and combinations thereof.

3. The method of claim 1 where the filtered water-based fluid has a pH greater than at least 8.5.

4. The method of claim 3 where the water-based fluid has a pH ranging from about 4 to about 7 prior to flowing through the filtration equipment.

5. The method of claim 1 where the effective amount of diatomaceous earth within the filter media ranges from about 2 pounds per one hundred barrels (100 bbl) independently to about 50 lb per one barrel (1 bbl) of water-based fluid.

6. The method of claim 1 where the at least one alkaline metal earth metal or compound thereof is selected from the group consisting of magnesium, calcium, strontium, barium, and combinations thereof; and, magnesium oxide, magnesium hydroxide, magnesium carbonate hydroxide, calcium oxide, calcium hydroxide, and combinations thereof.

7. The method of claim 1 where the effective amount of at least one alkaline earth metal or compound thereof ranges from about 2 pounds per one hundred barrels (100 bbl) independently to about 50 lb per one barrel (1 bbl) of water-based fluid.

8. The method of claim 1 where the filter media reacts with the at least one solid to form a precipitate, and where the method further comprises separating the precipitate from the water-based fluid.

9. The method of claim 1 further comprising where the water-based fluid comprises a hydrazine complexing agent prior to flowing the water-based fluid through the filtration equipment.

10. The method of claim 9 where the amount of hydrazine complexing agent ranges from about 10 wt % to about 50 wt %, based on the water-based fluid.

11. The method of claim 9 where the at least one solid comprises at least one metal and the mole ratio of hydrazine complexing agent to the at least one metal in the at least one metal ranges from about 2:1 to about 3:1.

12. The method of claim 1 where at least partially separating the solid(s) from the water-based fluid is performed by by a process selected from the group consisting of filtering, centrifuging, settling, and combinations thereof.

13. The method of claim 1 where the at least one solid comprises at least one metal, and the at least partially separating the solid(s) comprises at least partially separating the at least one metal, and the method further comprises:
reusing at least a portion of at least one metal at least partially separated to create a brine by combining the at least one metal with water.

14. A method for removing at least one solid from a water-based fluid comprising:
flowing a water-based fluid through filtration equipment at least a first time where the filtration equipment comprises a filter media, and the filter media in turn comprises:
from about 2 pounds per one hundred barrels (100 bbl) to about 50 lb per one barrel (1 bbl) of water-based fluid of diatomaceous earth and
from about 2 pounds per one hundred barrels (100 bbl) to about 50 lb per one barrel (1 bbl) of water-based fluid of at least one alkaline earth metal or compound thereof to at least partially remove the at least one solid from the water-based fluid, where the at least one solid is a metal selected from the group consisting of zinc, iron, manganese, mercury, nickel, cations of these metals, and combinations thereof; and
at least partially separating the solid(s) from the water-based fluid to form a filtered water-based fluid.

15. The method of claim 14 where the filtered water-based fluid has a pH greater than at least 8.5.

16. The method of claim 14 where the water-based fluid has a pH ranging from about 4 to about 7 prior to flowing through the filtration equipment.

17. The method of claim 14 where the at least one alkaline metal earth metal or compound thereof is selected from the group consisting of magnesium, calcium, strontium, barium, and combinations thereof; and, magnesium oxide, magnesium hydroxide, magnesium carbonate hydroxide, calcium oxide, calcium hydroxide, and combinations thereof.

18. The method of claim 14 where the filter media reacts with the at least one solid to form a precipitate, and where the method further comprises separating the precipitate from the water-based fluid.

19. The method of claim 14 further comprising where the water-based fluid comprises a hydrazine complexing agent prior to flowing the water-based fluid through the filtration equipment; where the amount of hydrazine complexing agent ranges from about 10 wt % to about 50 wt %, based on the water-based fluid.

20. A method for removing at least one solid from a water-based fluid comprising:
flowing a water-based fluid through a filter press at least a first time where the filter press comprises a filter media, and the filter media in turn comprises:
from about 2 pounds per one hundred barrels (100 bbl) to about 50 lb per one barrel (1 bbl) of water-based fluid of diatomaceous earth and
from about 2 pounds per one hundred barrels (100 bbl) to about 50 lb per one barrel (1 bbl) of water-based fluid of at least one alkaline earth metal or compound thereof to at least partially remove the at least one solid from the water-based fluid, where the at least one solid is a metal selected from the group consisting of zinc, iron, manganese, mercury, nickel, cations of these metals, and combinations thereof; and
where the water-based fluid comprises a hydrazine complexing agent prior to flowing the water-based fluid through the filter press;
where the amount of hydrazine complexing agent ranges from about 10 wt % to about 50 wt %, based on the water-based fluid; and
at least partially separating the solid(s) from the water-based fluid to form a filtered water-based fluid.
